(19) United States
(12) Patent Application Publication
(10) Pub. No.: US 2023/0330600 A1
(43) Pub. Date: Oct. 19, 2023

(54) COATED ULTRAFILTRATION DEVICES

(71) Applicant: CORNING INCORPORATED, CORNING, NY (US)

(72) Inventors: Ana Maria del Pilar Pardo, Portsmouth, NH (US); Allison Jean Tanner, Portsmouth, NH (US)

(21) Appl. No.: 18/018,987

(22) PCT Filed: Jul. 28, 2021
(86) PCT No.: PCT/US2021/043387

§ 371 Date: Jan. 31, 2023

Related U.S. Application Data
(60) Provisional application No. 63/059,425, filed on Jul. 31, 2020.

(51) Int. Cl. B01D 61/18; B01D 61/14; B01D 71/68; B01D 63/16; B01D 69/02; B01D 67/00; B01L 3/00

(52) U.S. Cl. CPC B01D 61/18; B01D 61/145; B01D 71/68; B01D 63/16; B01D 69/02; B01D 67/0088; B01L 3/5021; B01D 2325/34; B01L 2300/0681; B01L 2300/042

(57) ABSTRACT

A coated ultrafiltration device comprises an upper chamber; a lower chamber; a filtration chamber disposed between the upper chamber and lower chamber; and a semipermeable membrane disposed substantially vertically around the filtration chamber. The semipermeable membrane comprises a coating on a portion of the semipermeable membrane exposed to the filtration chamber, wherein the coating comprises an ultra-low attachment coating that is not derived from animal sources.

### CROSS-REFERENCE TO RELATED APPLICATIONS

This is a national stage application under 35 U.S.C. § 371 of International Application No. PCT/US2021/043387, filed Jul. 28, 2021, which claims the benefit of priority under 35 U.S.C. § 119 of U.S. Provisional Application Ser. No. 63/059,425 filed on Jul. 31, 2020, the content of which is relied upon and incorporated herein by reference in its entirety.

### TECHNICAL FIELD

This disclosure generally relates to coated ultrafiltration devices.

### BACKGROUND

Ultrafiltration techniques are used in many industries. For example, water purification and healthcare applications like dialysis use ultrafiltration techniques. In the biomolecule industry, ultrafiltration devices may be used for concentration or separation of biomolecules. However, conventional ultrafiltration devices suffer from binding of biomolecules to a membrane in the device, leading to loss of biomolecules recovered from the ultrafiltration device.

### SUMMARY

Embodiments of the invention provide ultrafiltration devices for isolating biomolecules from aqueous solutions. Devices of the present disclosure comprise a coating that allows for increased recovery of biomolecules from ultrafiltration devices, compared to standard ultrafiltration device recovery.

In an aspect of the invention, a coated ultrafiltration device is provided. The device comprises an upper chamber; a lower chamber; a filtration chamber disposed between the upper chamber and lower chamber; and a semipermeable membrane disposed in a substantially vertical orientation around the filtration chamber, the semipermeable membrane comprising a coating on a portion of the semipermeable membrane exposed to the filtration chamber.

In some embodiments, the coating may comprise a non-animal-derived ultra-low attachment coating, or an ultra-low attachment coating that is not derived from animal sources.

In some embodiments, the ultrafiltration device may comprise a cylindrical tube shape. In some embodiments, the ultrafiltration device may comprise a conical bottom.

In some embodiments, the semipermeable membrane may comprise a polyethersulfone (PES) membrane. In some embodiments, the semipermeable membrane may comprise two membrane portions vertically disposed around the filtration chamber. In some embodiments, the semipermeable membrane may comprise a molecular weight cut-off (MWCO) selected from the group consisting of a 5,000 MWCO, a 10,000 MWCO, a 30,000 MWCO, a 50,000 MWCO, a 100,000 MWCO, and a 300,000 MWCO.

In some embodiments, the ultrafiltration device may be suitable for storage at room temperature prior to use. In some embodiments, the ultrafiltration device may be stored at a temperature of about 4° C. prior to use.

In some embodiments, the ultrafiltration device comprises a cap to seal the upper chamber.

In some embodiments, the ultrafiltration device may further comprise an upper portion and a lower portion. The upper portion of the ultrafiltration device may comprise the upper chamber, filtration chamber, and semipermeable membrane. The lower portion may comprise the lower chamber. In some embodiments, the upper portion is releasably connected to the lower portion.

In some embodiments, the ultrafiltration device is a sterile ultrafiltration device.

In some embodiments, the ultrafiltration device is shaped to be received in a centrifuge. In some embodiments, the ultrafiltration device comprises a 1 ml centrifuge tube with a 500 μl filtration chamber capacity. In some embodiments, the ultrafiltration device comprises a 15 ml centrifuge tube with a 6 ml filtration chamber capacity. In some embodiments, the ultrafiltration device comprises a 50 ml centrifuge tube with a 20 ml filtration chamber capacity.

In some embodiments, ultrafiltration devices are used for extracellular vesicle purification.

### BRIEF DESCRIPTION OF THE DRAWINGS

FIG. 1 shows an embodiment of a coated ultrafiltration device.

FIG. 2 shows an embodiment of a coated ultrafiltration device.

FIG. 3 shows an embodiment of a coated ultrafiltration device.

FIG. 4 shows an embodiment of a coated ultrafiltration device.

FIG. 5 is a graph comparing isolation of particles in a standard ultrafiltration device and an embodiment of a coated ultrafiltration device.

FIG. 6 is a graph comparing particle counts in collections from a standard ultrafiltration device and from an embodiment of a coated ultrafiltration device.

### DETAILED DESCRIPTION

In embodiments of the invention, coated ultrafiltration devices are provided that reduce non-specific binding of biomolecules to a semipermeable membrane of the ultrafiltration device. The reduced binding of biomolecules to the semipermeable membrane is achieved by applying an ultra-low attachment reagent to the membrane. The ultra-low attachment reagent is a non-animal-derived ultra-low-attachment reagent, or an ultra-low attachment reagent that is not derived from animal sources. Application of the non-animal-derived ultra-low attachment reagent to the semipermeable membrane increases recovery of biomolecules that can be lost by non-specific binding to the membrane of the ultrafiltration device.

By using the non-animal-derived ultra-low attachment reagent coating, ultrafiltration devices according to embodiments of the invention are shelf stable at room temperature and do not require refrigeration, storage at special conditions, or special packaging. Furthermore, devices according to embodiments of the invention provide a sterile, pre-coated ultrafiltration device that is ready-to-use straight from the packaging. Unlike standard devices, devices according to embodiments of the invention do not require additional process steps for preparation of the ultrafiltration and use within a short time frame thereafter, such as within about 72 hours after completion of the process steps.

Devices according to embodiments of the invention provide an improved user experience from that of conventional ultrafiltration devices. Users can unpackage the device for immediate use, without requiring an added, lengthy, multistep process of blocking or coating the device in attempts to improve biomolecule recovery. For example, conventional blocking techniques may require additional processing steps of washing the device with water and spinning liquid through the device, removing residual water by pipetting while attempting to avoid damage to the membrane with the pipette tip, filling the device with a blocking solution (examples include animal-derived blocker solutions such as powdered milk and bovine serum albumin (BSA) and surfactants), incubating the filled device for at least two hours or overnight, pouring the blocking solution out, rinsing the device multiple times with water, and spinning the device. However, such conventional blocking procedures require refrigerated storage, and the blocked device must be used shortly after the blocking procedure is finished, such as within about 72 hours after blocking.

In contrast, devices according to embodiments of the invention do not require blocking or coating by the user and do not require use of that device within a short time period thereafter. Devices according to embodiments of the invention are ready to use straight from the package and can be stored at room temperature (e.g. about 15° C. to about 25° C.) until ready to use. Devices according to embodiments of the invention may also be stored at refrigerated or cold temperatures, such as about 4° C., but do not require refrigerated storage to remain effective.

Embodiments of the invention provide ultrafiltration devices for isolating biomolecules from aqueous solutions. Devices of the present disclosure comprise a coating that allows for increased recovery of biomolecules from ultrafiltration device, compared to standard ultrafiltration device recovery. Devices according to embodiments of the invention may be used with biological fluids and aqueous solutions. In some embodiments, the devices may be used for concentration of biological samples, purification of biological samples, or a combination thereof.

In some embodiments, ultrafiltration devices are used for extracellular vesicle purification. Extracellular Vesicles (EVs) are biomolecules secreted by cells, and EVs are of growing interest due to their importance in intercellular communication. Ultrafiltration is one method that may be used to concentrate the EVs from the cell culture medium.

Devices according to embodiments of the invention may be disposable, single use ultrafiltration devices. In certain aspects of the invention, the ultrafiltration device is subjected to centrifugal force to concentrate or purify biological samples. In some embodiments, applying the centrifugal force decreases the volume of a solution. In some embodiments, applying the centrifugal force changes out the solvent in the solution, such as in desalting. In some embodiments, applying the centrifugal force indiscriminately separates desired biomolecules from undesired biomolecules based on molecular weight.

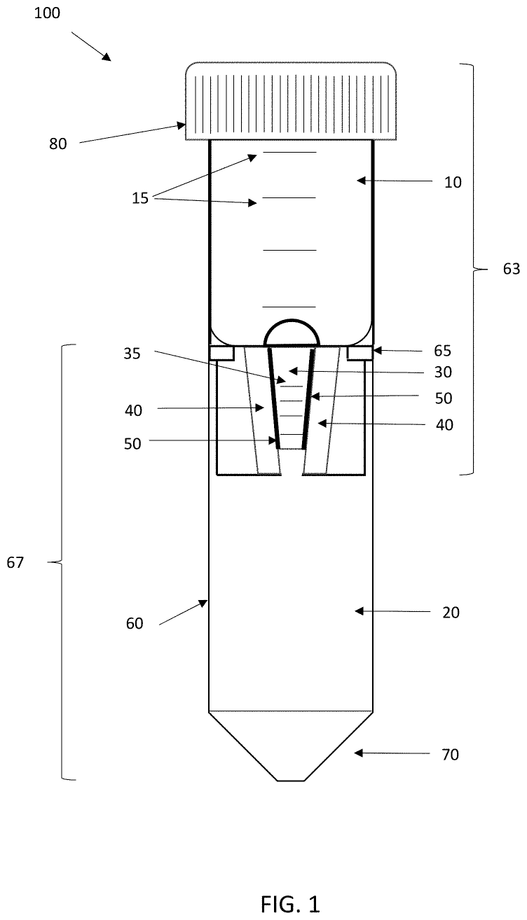

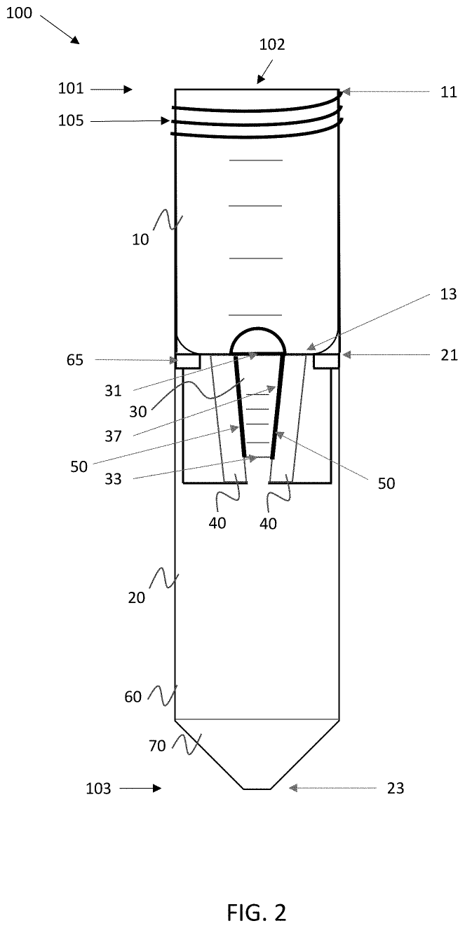

FIGS. 1-4 show coated ultrafiltration devices 100 according to embodiments of the invention. The coated ultrafiltration device 100 comprises an upper chamber 10 at a top end 101 of the device and a lower chamber 20 at a bottom end 103 opposite the top end 101 of the device. The lower chamber 20 comprises a top end 21 and a bottom end 23. The upper chamber comprises a top end 11 and a bottom end 13. A filtration chamber 30 is disposed at a bottom end 13 of the upper chamber 10, the filtration chamber 30 disposed between the upper chamber 10 and lower chamber 20. The filtration chamber 30 comprises an open top end 31 in communication with a bottom end 13 of the upper chamber 10, a closed bottom end 33 opposite the top end 31, and a sidewall 37 disposed between the top end 31 and the bottom end 33 to form a conically shaped filtration chamber configured to hold a volume of liquid. A semipermeable membrane 40 is disposed substantially vertically around the filtration chamber 30, the semipermeable membrane 40 comprising a coating 50 on a portion or surface of the semipermeable membrane 40 exposed to the filtration chamber 30. In some embodiments, the coating is disposed on a surface of the membrane 40 that forms at least a portion of a sidewall 37 of the filtration chamber 30. The semipermeable membrane 40 disposed substantially vertically around the filtration chamber 30 may form at least a portion of the sidewall 37 of the filtration chamber 30.

The body 60 of the ultrafiltration device 100 may be any suitable shape. In some embodiments, the body 60 of the ultrafiltration device 100 may comprise a cylindrical tube shape. In some embodiments, the body 60 of the ultrafiltration device 100 may further comprise a conical bottom portion 70. As shown in FIG. 1, the ultrafiltration device 100 may further comprise a cap 80, such as a threaded cap that screws on to a threaded portion 105 of the ultrafiltration device body 60. In some embodiments, the ultrafiltration device 100 may further comprise graduated volume markings 15 for the upper chamber 10 and graduated volume markings 35 for the filtration chamber 30.

In some embodiments, the ultrafiltration device 100 may comprise an upper portion 63 and a lower portion 67. The upper portion 63 may comprise the upper chamber 10, filtration chamber 30, and semipermeable membrane portion 40. The lower portion 67 may comprise the lower chamber 20. In some embodiments, the upper portion 63 and lower portion 67 are detachable from one another. In such an embodiment, the upper portion 63 and lower portion 67 may be attached by any suitable releasable connection 65, such as a threaded connection, snap connection, interlocking connection or any other suitable releasable connection.

The filtration chamber 30 is disposed at a bottom end 13 of the upper chamber 10. Together, the filtration chamber 30 and upper chamber 10 form a volume of the upper portion 63 of the ultrafiltration device 100. To fill the volume of the upper portion 63, such as with a liquid or aqueous solution, a user may remove the cap 80 to expose an opening or aperture 102 at a top end 101 of the device 100. Liquid or solution may be added through the aperture 102, the liquid flowing downward from the aperture 102 to the filtration chamber 30 at a bottom end of the upper portion 63. While the user adds the liquid, the volume of the liquid increases in the upper portion 63, with the level of the liquid rising from the bottom end 33 of the filtration chamber 30 upwards to the top end 101 of the device 100, thereby filling the filtration chamber 30 and then filling the upper chamber 10.

In some embodiments, the semipermeable membrane 40 may comprise a low-binding polyethersulfone (PES) membrane. In some embodiments, devices comprise a semi-permeable membrane that has a specific molecular weight cut-off (MWCO). The MWCO specifies the size of molecules that can pass through the semi-permeable membrane when a force is applied. In some embodiments, the semipermeable membrane 40 may comprise two membrane portions disposed in a substantially vertical orientation around the filtration chamber 30. For example, the semipermeable membrane 40 may form opposite sides of a thin channel filtration chamber 30 which, along with the upper chamber 10, holds a solution to be concentrated (or desalted) in the upper portion 63 of the tube.

In embodiments, the force is applied by centrifugation to encourage the passage through the semi-permeable membrane of solvents and biomolecules equal to or smaller than the MWCO. Non-limiting examples of force include fixed angle rotor centrifugation devices and a swing bucket rotor centrifugation devices, such as the Beckman Allegra 25R with TS-5.1-500 swing-out rotor with BUC 5 buckets and 368327 adaptors (Beckman Coulter, Inc., Indianapolis, IN); Beckman TA-10.250 25° fixed angle rotor with 356966 adaptors (Beckman Coulter, Inc., Indianapolis, IN); Heraeus Multifuge 3 S-R with (Heraeus/Sorvall) 75006445 swing out rotor with 75006441 buckets (ThermoFisher Scientific, Waltham, MA).

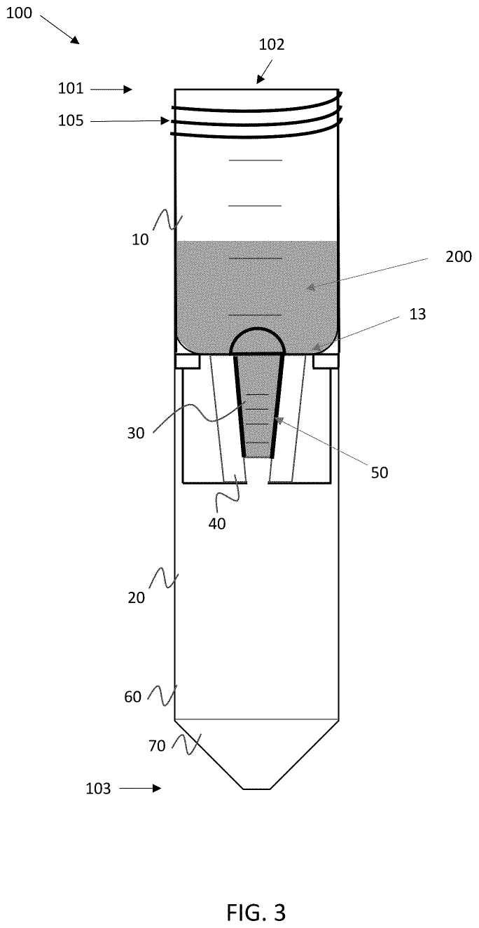

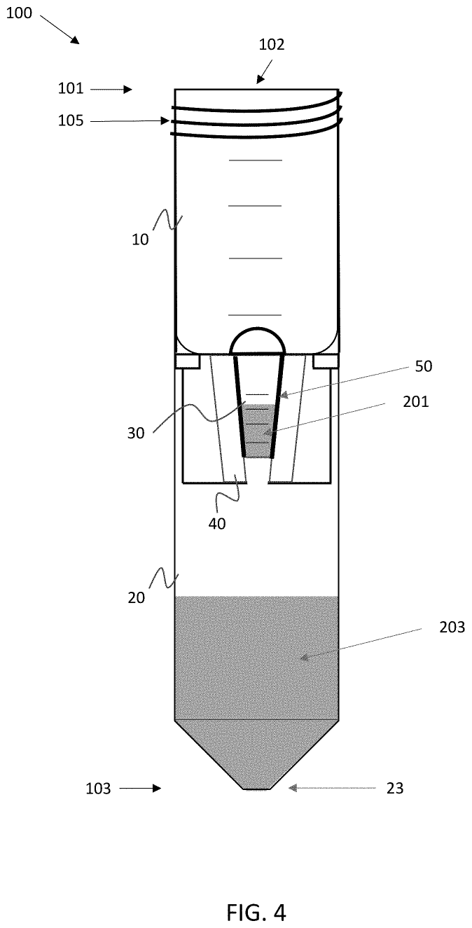

FIG. 3 shows an embodiment of an ultrafiltration device before centrifugation. FIG. 4 shows an embodiment of an ultrafiltration device after centrifugation. Once the ultrafiltration device 100 containing liquid or aqueous solution 200 is subjected to a force, such as a centrifugal force, particles smaller than or equal to the MWCO of the membrane move through the tube from the upper chamber 10, to the filtration chamber 30, through the membrane 40, and into the lower chamber 20, while the concentrate 201 remains in the filtration chamber 30 and is typically greatly reduced in volume. Thus, when force is applied, solution in the filtration chamber 30 having particles smaller than the MWCO of the membrane radially moves from the filtration chamber 30 through the semipermeable membrane 40 to collect in the lower chamber 20 as filtrate 203. After centrifuging, filtrate 203 can be collected from the lower chamber 20 in the lower portion 67 of the device, and concentrate 201 can be collected from the filtration chamber 30 in the upper portion 63 of the device.

Components of the ultrafiltration device may be constructed of any suitable material for use with biological fluids and aqueous solutions. In some embodiments, the body of the ultrafiltration device is formed from polycarbonate. In some embodiments, the filtration chamber is formed from polycarbonate. In some embodiments, the cap for the device is polypropylene. In some embodiments, the membrane is a polyethersulfone membrane. Devices according to embodiments of the invention may be sterilized using an ethanol solution, such as a 70% ethanol solution, or a sterilizing gas mixture.

In some embodiments, the ultrafiltration device is a Corning® Spin-X® ultrafiltration (UF) concentrator, such as a Spin-X® UF 20 concentrator having a 20 mL capacity, Spin-X® UF 6 concentrator having a 6 mL capacity, or Spin-X® UF 500 concentrator having a 500 μL capacity (manufactured by Corning Incorporated, Corning, NY). In some embodiments, the semipermeable membrane is a low binding polyethersulfone (PES) membrane with a molecular weight cut-offs (MWCO) of 5,000, 10,000, 30,000, 50,000, 100,000, or 300,000 to meet concentrating needs. For example, a MWCO half to a third smaller than the protein to be concentrated should be chosen. In some embodiments, membranes within the ultrafiltration devices may have a 5,000 MWCO, 10,000 MWCO, 30,000 MWCO, 50,000 MWCO, 100,000 MWCO, 300,000 MWCO, or other suitable MWCO.

The coating 50 allows for increased recovery of biomolecules from ultrafiltration devices, compared to standard ultrafiltration device recovery. In some embodiments, the coating 50 may comprise a non-animal-derived ultra-low attachment coating. The coating may be applied by any suitable method of coating. Non-limiting examples of methods of coating include liquid coating, dip coating, spray coating, spin coating, chemical vapor deposition, plasma enhanced chemical vapor deposition, among others. In some embodiments, the non-animal-derived ultra-low attachment coating may comprise an ultra-low attachment powder and purified water, such as ultrapure water generated from a purification system like the Milli-Q™ Reference Ultrapure Water Purification System (MilliporeSigma, Burlington, MA). In some embodiments, the ULA coating may be covalently bonded to the surface by UV cross-linking. In some embodiments, the non-animal-derived ultra-low attachment coating may comprise hydrogels such as agarose, polydimethylsiloxane (PDMS), and poly hydroxyethylmethacrylate (PolyHEMA). In some embodiments, the non-animal-derived ultra-low attachment coating may comprise 2-(methacryloyoxy)ethyl phosphorylcholine (MPC), which is a lipid-like molecule that can be used to create a low binding surface.

Some embodiments of the invention are directed to sterile, pre-coated ultrafiltration devices. For example, after devices have been coated, the devices may be sterilized by any suitable method, such as gamma irradiation. Conventional ultrafiltration devices required users to sterilize the devices, and options for sterilization were limited due to avoiding damage to the membrane within the device. For example, users were limited to sterilizing conventional ultrafiltration devices by running an ethanol solution through the device. In contrast, embodiments of the invention provide a ready-to-use, pre-coated, sterile ultrafiltration device.

Devices according to embodiments of the invention do not require special packaging or storage procedures prior to use. For example, devices may be stored at room temperature (e.g., about 15° C. to about 25° C.) conditions prior to use. In some instances, a user may require ultrafiltration of a sample that must be kept at cold temperatures—in such an example, devices according to embodiments of the invention may be stored at cold or refrigerated temperatures prior to use, such as about 4° C.

### Examples

In some embodiments, ultrafiltration devices are used for extracellular vesicle purification. Extracellular Vesicles (EVs) are biomolecules secreted by cells, and EVs are of growing interest due to their importance in intercellular communication. Ultrafiltration is one method that may be used to concentrate the EVs from the cell culture medium.

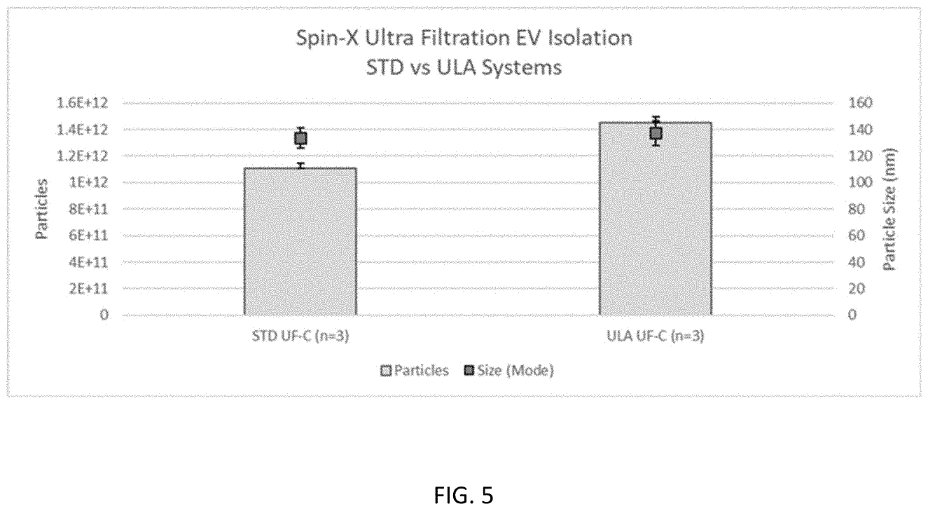

FIG. 5 shows a comparison of standard ultrafiltration devices and devices according to embodiments of the invention (ULA-coated ultrafiltration devices) (n=3). FIG. 5 compares EVs concentrated from standard ultrafiltration devices (STD UF-C) to ULA-coated ultrafiltration devices (ULA UF-C). The starting material subjected to ultrafiltration for EV collection was fetal bovine serum (FBS). Protein can aggregate and be counted as particles using nanoparticle tracking analysis (NTA). As shown in FIG. 5, the number of particles (EV and protein aggregates) recovered from the standard ultrafiltration devices is lower than the number of particles recovered from the ULA-coated ultrafiltration devices. The square boxes signify the typical size of the particles.

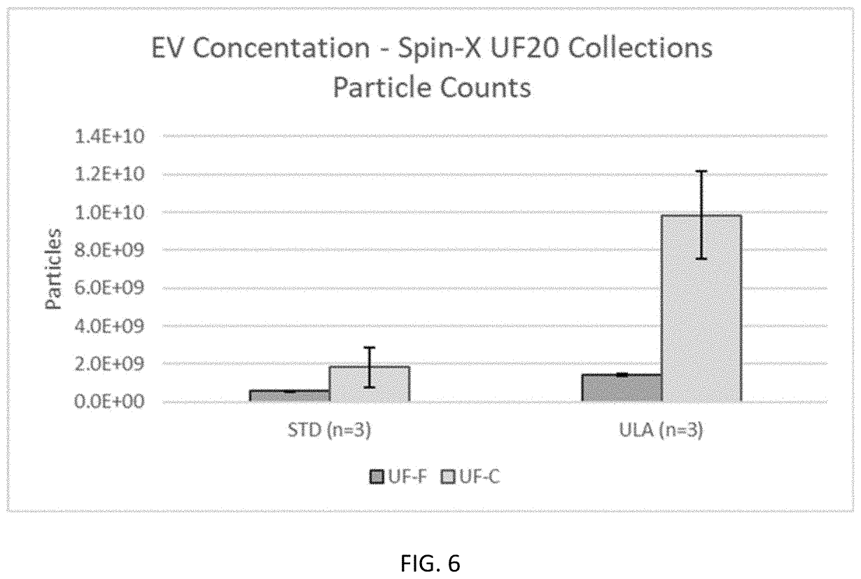

Another way to compare standard ultrafiltration devices to ULA-coated ultrafiltration devices is to use the amount of particles non-specifically bound to the semipermeable membrane and to compare the amount of particles (such as EVs) that come out in the filtrate and remain in the concentrate. FIG. 6 shows such a comparison between an uncoated, standard ultrafiltration device and a ULA-coated filtration device. Both devices received the same starting amount of particles. The starting material for this experiment was a known quantity of EV mixed with immunoglobin (IgG) protein. The darker colored bars indicate the number of particles that end up in the filtrate (UF-F). The lighter colored bars reflex the number of particles in the concentrate (UF-C) (n=3). As shown in FIG. 6, the total number of particles collected in the filtrate and concentrate of the standard (STD) non-coated ultrafiltration devices was 2.4×10\hat{ }9, whereas the total number of particles collected in the filtrate and concentrate of the ULA-coated ultrafiltration devices was 1.1×10\hat{ }10. Therefore, 8.6×10\hat{ }9 particles were unaccounted for in the standard (uncoated) ultrafiltration device. Those missing particles are likely non-specifically bound to the semipermeable membrane of the devices tested.

The following experimental procedures were used to generate the data shown in FIG. 5 and FIG. 6.

Materials

Materials used include Spin-X® UF20 100K MWCO Concentrators (Corning Incorporated, Cat. No. 431491, Corning, NY), ULA solution (manufacturing procedure below), Fetal bovine serum (FBS, Corning Incorporated Cat. No. 35-010-CV), NanoSight NS300 for Nano Tracking Analysis (NTA) of particle counts and size distribution, MilliQ™ grade water (0.22 μm filtered), Frozen exosomes (˜1×10e10) (SBI, Cat. No. EXOP-110A-1), and 1×PBS (Cat. No. 21-031-CM) (0.22 μm filtered).

Method of ULA Coating

0.1 g of PA04 (Ultra-Low Attachment powder, SurModics, Inc., Eden Prairie, MN) was weighed and added to 100 mL milliQ water (ultrapure water generated from using Milli-Q™ Reference Ultrapure Water Purification System manufactured by MilliporeSigma, Burlington, MA) and mixed using a magnetic stir bar and plate. Once the reagent was dissolved, the caps were removed from the ultrafiltration devices and 6 mL of the ULA solution was dispensed into each ultrafiltration device. This was enough to fill the thin channel filtration chamber to contact the entire semipermeable membrane exposed to the channel. The vessels were placed under a UV “D” bulb (peak wavelength 300-440 nm) to receive 4500 mJ of energy. Following crosslinking, the ULA solution was aspirated from the devices and the caps replaced. The Spin-X® UF 20 (Corning Incorporated, Corning, NY) devices were stored at 4° C. until use. Alternate coating methods include air drying the membrane prior to storage to permit storage at room temperature.

Ultrafiltration for EV concentration

10 mL of FBS was Added to Four Standard (STD) and Four ULA-Coated (ULA) Spin-X® UF 20 devices (Corning Incorporated, Corning, NY). Solutions were concentrated using a swinging bucket rotor in the centrifuge set at 3,000×g for 20 min. Repeated the centrifugation step until concentrate volume was under 2 mL. Collected the concentrate (top chamber, UF-C) and filtrate (bottom chamber, UF-F). Particle concentration, and size distribution were determined using the NS300 instrument and NTA 3.3 software. Samples were diluted with water prior to analysis to achieve a particle count range between 20 and 80 particles per frame. The NS300 instrument was set to take three, 60 second videos per sample for NTA.

Although multiple embodiments of the present disclosure have been illustrated in the accompanying Drawings and described in the foregoing Detailed Description, it should be understood that the disclosure is not limited to the disclosed embodiments, but is capable of numerous rearrangements, modifications and substitutions without departing from the disclosure as set forth and defined by the following claims.

What is claimed is:

1. A coated ultrafiltration device comprising:
an upper chamber;
a lower chamber;
a filtration chamber disposed between the upper chamber and lower chamber; and
a semipermeable membrane disposed substantially vertically around the filtration chamber, the semipermeable membrane comprising a coating on a portion of the semipermeable membrane exposed to the filtration chamber.

2. The device of claim 1, wherein the coating comprises a non-animal-derived ultra-low attachment coating.

3. The device of claim 1, wherein the ultrafiltration device comprises a cylindrical tube shape.

4. The device of claim 3, wherein the ultrafiltration device comprises a conical bottom.

5. The device of claim 1, wherein the filtration chamber is a conically shaped filtration chamber comprising:
a closed bottom end,
an open top end opposite the bottom end, and
a sidewall disposed between the bottom end and top end to form the conically shaped filtration chamber.

6. The device of claim 5, wherein the open top end is disposed at a bottom end of the upper chamber and is in communication with the upper chamber.

7. The device of claim 5, wherein the semipermeable membrane disposed substantially vertically around the filtration chamber forms at least a portion of the sidewall of the filtration chamber.

8. The device of claim 1, wherein the semipermeable membrane comprises a polyethersulfone membrane.

9. The device of claim 1, wherein the semipermeable membrane comprises two membrane portions disposed substantially vertically around the filtration chamber.

10. The device of claim 1, wherein the device is suitable for storage at room temperature prior to use.

11. The device of claim 1, wherein the device is stored at a temperature of about 4° C. prior to use.

12. The device of claim 1, wherein the device comprises a cap to seal the upper chamber.

13. The device of claim 1, further comprising an upper portion and a lower portion,
wherein the upper portion of the device comprises the upper chamber, filtration chamber, and semipermeable membrane; and
wherein the lower portion comprises the lower chamber.

14. The device of claim 13, wherein the upper portion is releasably connected to the lower portion

15. The device of claim 1, wherein the device is sterile.

16. The device of claim 1, wherein the ultrafiltration device is shaped to be received in a centrifuge.

17. The device of claim 1, wherein the device comprises a 1 ml centrifuge tube with a 500 μl filtration chamber capacity.

18. The device of claim 1, wherein the device comprises a 15 ml centrifuge tube with a 6 ml filtration chamber capacity.

19. The device of claim 1, wherein the device comprises a 50 ml centrifuge tube with a 20 ml filtration chamber capacity.

20. The device of claim 1, wherein the semipermeable membrane comprises a molecular weight cut-off (MWCO) selected from the group consisting of a 5,000 MWCO, a 10,000 MWCO, a 30,000 MWCO, a 50,000 MWCO, a 100,000 MWCO, and a 300,000 MWCO.
